(19) United States
(12) Patent Application Publication
(10) Pub. No.: US 2008/0269960 A1
(43) Pub. Date: Oct. 30, 2008

(54) Method for Transporting Goods and Installation for Carrying Out Said Method

(76) Inventor: Helmut Kostmann, Hart Bei Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/628,445

(22) PCT Filed: Jun. 6, 2005
(86) PCT No.: PCT/AT05/00196

§ 371 Date: Dec. 29, 2006

(30) Foreign Application Priority Data
Jun. 4, 2004 (AT) A 971/2004

(51) Int. Cl. G06F 19/00

(52) U.S. Cl. 701/2

(57) ABSTRACT

The invention relates to a method for transporting goods (2) by means of at least one vehicle that can be autonomously displaced in a store. Said method is characterised by a combination of the following elements: a vehicle (8) provided with a computing unit (7) receives, preferably by radio, at least one instruction relating to a) a product (2) to be fetched or delivered, and/or b) a target location e.g. a storage area (1) in the store, and/or c) a path to be covered. According to the invention, the computing unit (7) of the vehicle (8) establishes the target location and optimum or approximately optimum route for the instruction a), and the optimum or approximately optimum route for the instruction b), and starts the displacement transaction for the instructions a) or b) or c). The vehicle (8) is activated by the computing unit (7) at the target location, in such a way as to automatically receive or deliver the product (2) or to load or unload the same, whereupon optionally, if another instruction is provided, another product (2) is fetched or the loaded product is guided to another target location defined in an instruction relating to a), b) and/or c).

The invention relates to a method for transporting goods, comprising at least one vehicle which can be autonomously displaced in a store, and to an installation for carrying out said method.

The state of the art in current storehouse and production logistics is to either use manual handcarts or a container or box conveyor technology for transport processes within a store in the area of boxes and containers, but not for pallets.

Both the one as well as the other is linked to serious disadvantages. The use of manual handcarts mean a high use of human resources, the installation of conveyor technology requires high investments, especially when a store with a large number and variety of goods (weight, dimensions, likelihood of breakage, etc.) needs to be operated.

DE 101 42 395 A1 describes a storehouse and transport system in modular configuration with one or several shelf cells for received stored goods in several shelf planes and a large number of rail paths which are arranged at the level of the individual shelf planes. Several rail-bound vehicles move on the rail paths, comprising means for receiving and delivering the stored goods. The vehicles are controlled independent from each other via a central control computer and are supplied externally in a wireless manner with power.

EP 1 352 817 A1 discloses a transport device and a method for the transport of components along a transport section. In order to enable the transport of long components, the transport vehicles are coupled by the component itself.

DE 38 23 540 C1 discloses a method for operating a shelf chute for piece goods, in which piece goods are pushed into the chute from the one chute side for charging the chute. The piece goods are mechanically coupled in the chute for forming a train. For removal purposes, a piece good permanently at the end of the chute is pulled, with such piece good being detached from the piece good train when the piece good which is next in the direction of removal is pulled to a predetermined position.

WO 01/70602 A2 shows a commissioning device with product storage means arranged in a shelf in which products are stacked, with the lowermost product in the stack of a chosen product storage means being capable of being pushed out by a positioning push-out unit in the transversal direction of the shelf.

A similar device for commissioning a shelf is known from WO 03/011722 A1, with the shelf comprising at least one lift and compartments for containers or tablets to be unloaded in addition to plane operating devices which can be operated independent of each other.

A system and a method are known from U.S. Pat. No. 5,684,696 A with which autonomously operated vehicles are enabled to move along a continuous path.

An obstruction data processing system for unmanned self-controlled vehicles is known from U.S. Pat. No. 4,809,178 A, with which the vehicle automatically moves around obstructions situated on the route.

US 2004/0091338 A1 discloses a transfer system and an apparatus for workpiece containers, with the vehicles driving between different horizontal supply platforms. The transfer system comprises a vertical movement unit which brings the vehicle to the processing stations. The system is controlled centrally. Centrally controlled systems of this kind come with the considerable disadvantage that they are too inflexible and too slow in order to allow for high throughputs.

DE 298 08 762 U1 describes a driverless transport vehicle with several storage areas for transport means arranged on the transport vehicle, with the transport vehicle comprising a handling apparatus for depositing and receiving the transport means at the storage areas and for depositing and receiving the transport means on stationary parking places situated on the side of the transport vehicle. The handling apparatus comprises a turning apparatus for turning the transport means about a vertical axis.

An automatic commissioning device is further known from DE 41 01 615 A1, comprising at least one magazine for storing piece goods in stacks and at least one push-out device associated with a magazine for the automatic ejection of individual piece goods from the magazine. Air nozzles are provided as push-out devices.

Furthermore, sorting devices with revolving sorting conveyors are known which comprise elements which are linked to each other and which are provided with goods carriers which are held in a tiltable way for receiving piece goods. The goods carriers are optionally tiltable in the region of goods removal devices about an axis extending in the conveying direction. A sorting device of this kind is known from AT 398.536 B.

DE 2 034 834 A1 further discloses a combined storage operating device in the manner of a movable loading unit for loading and unloading and transporting piece goods. The loading unit, consisting of a lifting mast and a lifting carriage, is connected by a coupling system with an accompanying storage part corresponding to the storage material which receives and carries the storage goods for loading and unloading in the storehouse.

DE 32 47 960 C1 discloses a conveying vehicle with a vehicle-bound store comprising several mutually separated storage areas and a vehicle-bound loading and unloading apparatus which separated from the same which is arranged for loading and unloading piece goods into separate storage areas. The driven vehicle is guided, especially by an overhead guide rail or by a hauling vehicle.

A conveying vehicle with a parking device for piece goods is known from DE 33 8 241 A1, arranged as a store with at least one storage leaf and comprising a loading and unloading device for storing and removing a piece good in each storage area. The loading and unloading device is arranged as a satellite vehicle which is entrained by the conveying vehicle itself for receiving the piece good. The satellite vehicle can extend there at least to one side automatically for receiving or delivering the piece good.

With all these known systems it is only possible to achieve either a very limited access number or a very limited variability.

In the case of known automatic commissioning machines, a push-out device with a separate motor or pneumatic devices is required for each type of product.

Especially in the case of a large variety of products such as in pharmaceutical stores, a large number of push-out devices are required.

It is the object of the present invention to avoid such disadvantages and difficulties and the provide a method of the kind mentioned above and an installation for realizing the method which make do with very few staff and low capital investment, but still offers a highly flexible conveyance of the goods, which shall also apply to very different goods stored in a store. Furthermore, the method and installation should be easy to adapt for a large variety of logistical requirements. It is especially an object of the present invention to enable a high access number. It is further the object to reduce the amount of work for loading and unloading storage areas in a store.

This object is achieved by a method of the kind mentioned above by the combination of the following features:
a vehicle provided with a computing unit receives, preferably by radio, at least one instruction relating to:
a) a product to be fetched or delivered, and/or
b) a target location, e.g. a storage area in the store, and/or
c) a path to be covered;
whereupon the computing unit of the vehicle establishes
   the target location and the optimum or approximately optimum route for instruction a);
   and the optimum or approximately optimum route for the instruction b);
   and starts the displacement transaction for the instructions a) or b) or c);
   with the vehicle being activated by the computing unit at the target location, in such a way as to automatically receive or deliver the product or to load and unload the same;
   whereupon optionally, if another instruction is provided, another product is fetched or the loaded product is guided to another target location defined in an instruction relating to a), b) and/or c).

Product shall mean here either an individual merchandise or also a container, e.g. a box, in which a plurality of goods is contained or introduced.

The relevant aspect is that the vehicles act in an autonomous fashion. This means that the vehicles, after receiving an instruction, are capable as a result of the computing unit situated on board of each vehicle and the interactive sensor devices situated on board to carry out orders automatically and/or in groups. As a result, even bulky goods for example can be transported jointly by several vehicles, with the vehicles communicating with each other without influence from a central control computer and chose a strategy saved in a database of each computing unit for fulfilling the instruction based on the instruction given. Such a strategy can be for example the forwarding of goods in a narrow corridor from vehicle to vehicle. The vehicles thus form a relay in order to forward the product from the first to the last vehicle.

The computing unit on board of each vehicle further allows the vehicles to pass crossings without collision without any control of a superior computer, such that the vehicles act according to the right of way rule like in road traffic.

As a result of their sensor systems and communications means between the vehicles, the vehicles are able to differentiate between real obstructions and a load-induced congestion and to evade accordingly or travel substitute routes without needing to receive commands from a central computer.

As a result of this independence, the number of vehicles which can be operated in one application on a central computer is virtually unlimited. The function of the central computer is limited to the transmission of instruction data and the distribution of data to the vehicles which are relevant for performing their orders. This information can be compared with the traffic jam reports of radio traffic announcements.

As already mentioned, it is known to use vehicles for conveying goods which are controlled by a central computer. Such systems can only be used for a limited number of vehicles due to the limited capacity of the central computer and also come with the disadvantage that only a relatively low number of access actions are possible. A substantial increase in the number of access actions cannot be achieved even with powerful central computers.

In order to provide a considerable improvement here, the invention pursues a completely different path, such that the control of the vehicle occurs completely autonomous on board of each vehicle by the computing unit and without any influence by a central computer outside of the vehicle. The difference between known centrally controlled systems and the vehicles which can be displaced autonomously and independently in accordance with the invention is similar to that of a remote-controlled marionette and an automatically acting robot. The number of access actions can be increased decisively and to a surprisingly high extent by using autonomously acting vehicles for installations for conveying goods.

According to a first preferred embodiment, the loading and/or unloading of a vehicle occurs passively, with at least one active loading and/or unloading element being preferably situated in the store and being activated upon arrival of the vehicle, preferably by means of the vehicle itself.

A further preferred embodiment is characterized in such a way that the loading and/or unloading of the vehicle occurs actively, for which purpose a displaceable loading and unloading element is activated which is arranged on the vehicle, e.g. a conveyor belt, a conveyor chain, conveyor rollers, etc, preferably by the vehicle itself.

Appropriately, the loading and unloading of the vehicle can occur automatically upon arrival of the vehicle at the loading or unloading point, i.e. by driving devices provided on the vehicle and/or by gravity.

For transporting a product with large dimensions it is advantageous when two or more vehicles cover at least a part of the route together by forming a functional unit and optionally jointly transport a product which with its dimensions exceeds the dimensions of an individual vehicle, with the loading and/or unloading of the functional unit appropriately being performed for the individual vehicles in parallel, i.e. simultaneously, or serially, i.e. by forwarding at least one product from vehicle to vehicle.

Such a functional unit consisting of two or more vehicles can also be used itself as a conveying device for conveying a product from one vehicle at one end of the functional unit to a vehicle at the other end of the same.

If the conveyance of a product should occur in not only one plane but in two or more superimposed planes, a product is advantageously conveyed by means of a vehicle in the vertical direction, which occurs by lifting or lowering a product rack provided on the vehicle.

It may also be appropriate however that a vehicle is lifted and/or lowered from one plane to a plane situated vertically above or below.

The standstill of a vehicle is not inevitably necessary for the loading and unloading of a vehicle. It can also occur for vehicles which are still in motion.

An installation for realizing the method is characterized by the combination of the following features:
a store for products, comprising a plurality of storage areas determined for the products;
at least one route along and/or between the storage areas;
at least one vehicle with a product rack for at least one product, which vehicle is equipped with a computing unit and is displaceable in an autonomous way;
with a running gear that can be activated by the computing unit, and
with a data transmission device for transmitting data sent at a switch point to the computing unit of the vehicle.

Preferably, the installation is characterized by a vehicle with an active loading and/or unloading element supplying the product rack, which can be activated by the computing unit and is active transversally to and/or along the traveling direction of the vehicle or also characterized by a vehicle whose product rack itself is arranged as a conveying device which acts transversally or along the traveling direction of the vehicle, which product rack can be activated by the computing unit.

As a result of the fact that that the vehicle itself comprises a loading and/or unloading element, such elements can be omitted at the storage area. This is especially advantageous for stores with a large number of storage areas such as pharmaceutical stores because the number of motors, air nozzles or the like can be reduced substantially. The vehicle-bound loading and/or unloading elements enable a completely different type of logistics. Thus it is possible to receive or deliver products during the travel of the vehicle, which thus allows dramatically increasing the number of access actions.

For conveying goods in more than one plane it is appropriate to make the product rack liftable and lowerable by means of a lifting device which can preferably be activated by the computing unit.

An especially simple type of loading of the vehicle can be achieved in such a way that the vehicle is provided with a driving device for automatic loading and/or unloading, which driving device can preferably be activated by means of the computing unit from an active position to a passive position and vice-versa.

In order to transport bulky goods or a large number of goods simultaneously, the installation is appropriately characterized by two or more vehicles which are equipped with a coupling device and which can be coupled into a functional unit, which coupling devices can preferably be activated by means of the computing unit. The coupling device is a logical coupling which is defined by communication of the vehicles. In the case of logical coupling, the distances between the vehicles are kept constant via the computing units. The vehicles need not touch each other inevitably and can be spaced from each other.

For an appropriate data transmission, the installation is characterized by a data transmission device for transmitting data entered at the switch point to the computing unit which is preferably arranged as a radio device and/or infrared interface and/or as a plug-in connection and/or is realized by sliding contacts and/or arranged as an ultrasonic device.

Preferably, the installation is characterized by at least one storage area with an active loading and/or unloading element which can preferably be activated by the computing unit of the vehicle.

For lifting and lowering the vehicle itself, the installation comprises a lifting and lowering device adjacent to a storage area which preferably can be activated by the computing unit of the vehicle.

A further preferred embodiment for especially simple loading of a vehicle is characterized by a storage area which is equipped with a gravity-induced conveying device such as an inclined gravity roller conveyor, with the storage area being provided on the track with a stop device for a product which can be activated or deactivated by the vehicle, either mechanically by the arrival at or movement of the vehicle past the storage area or by a computing unit.

With the features described in the claims with a single product, a large number of currently common products can be substituted in storage technology. Conveying technology, automatic commissioning machines, rack truck machines, carousel systems and sorters can be simplified. As a result, future commissioning stores are simplified in their entirety, they become more economic by a reduced need for human resources and their scope of function is expanded.

The invention will be explained below in closer detail by reference to several embodiments schematically shown in the drawings, wherein:

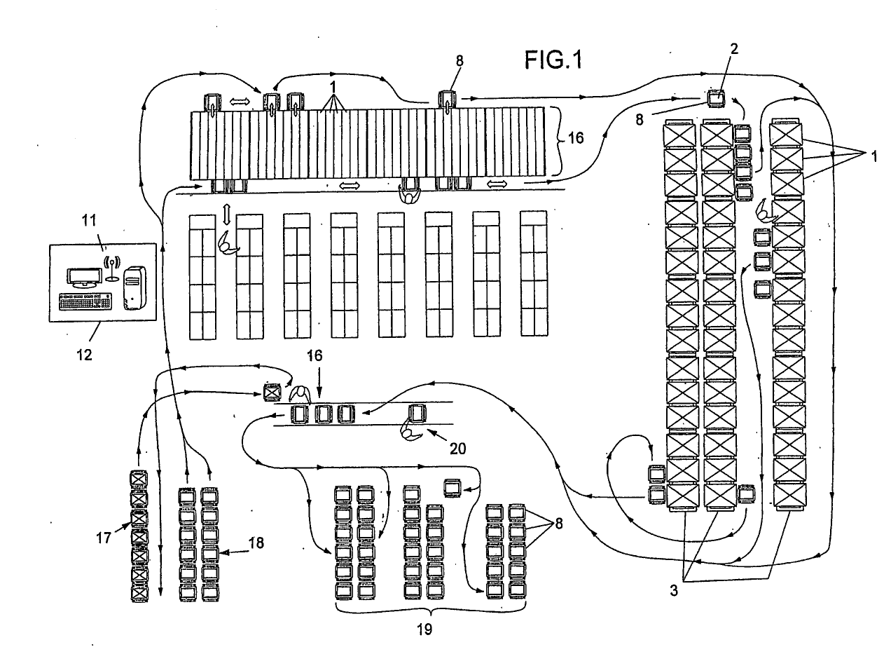

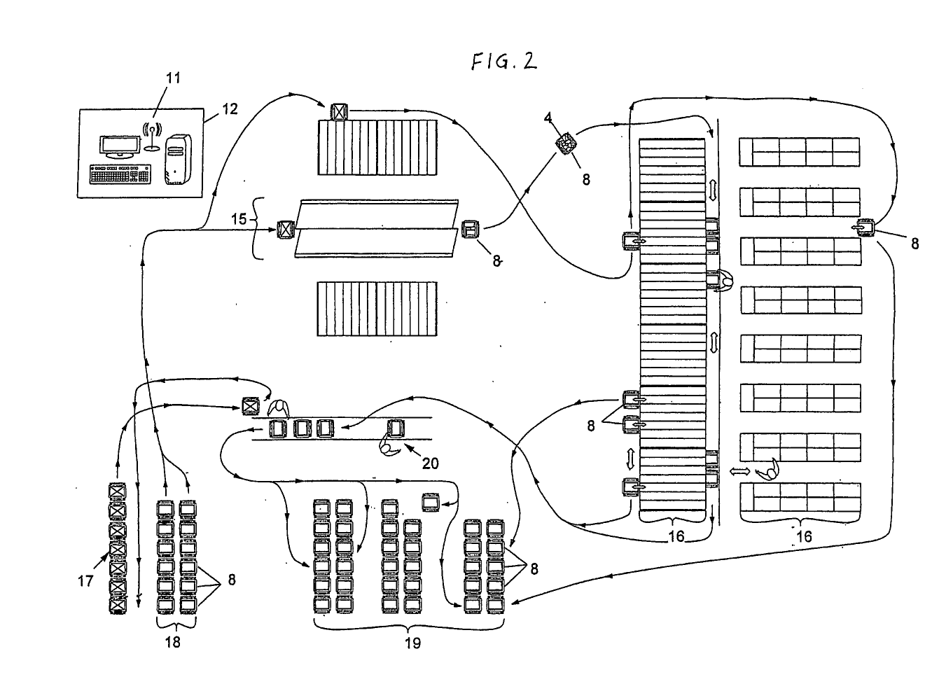

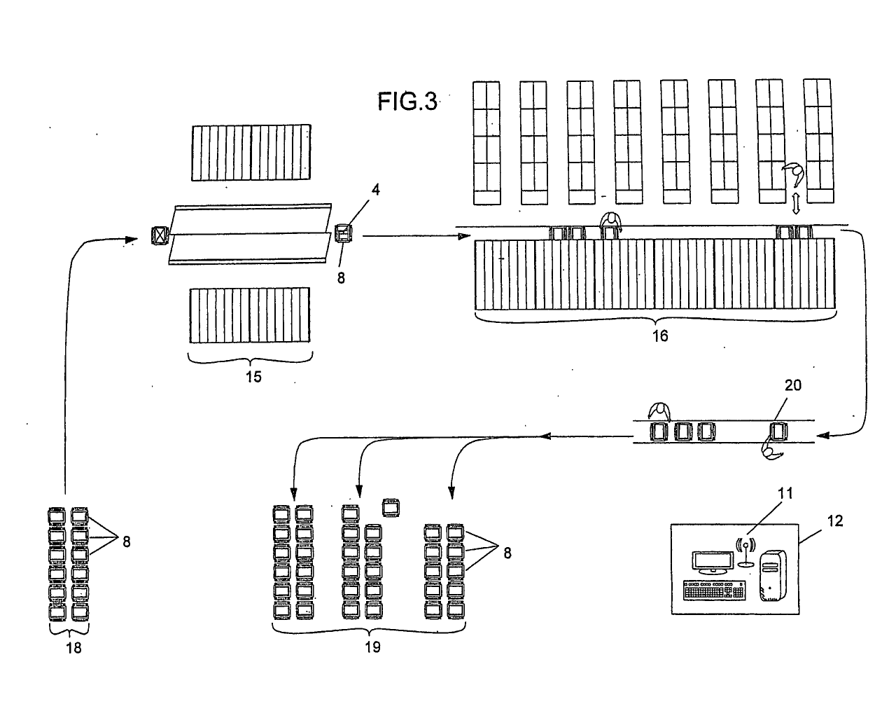

FIG. 1, FIG. 2 and FIG. 3 each show a top view of a store.

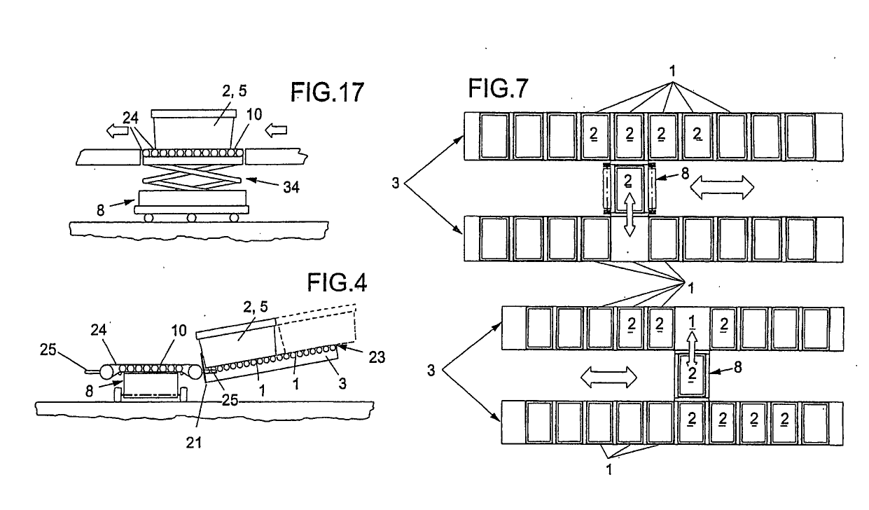

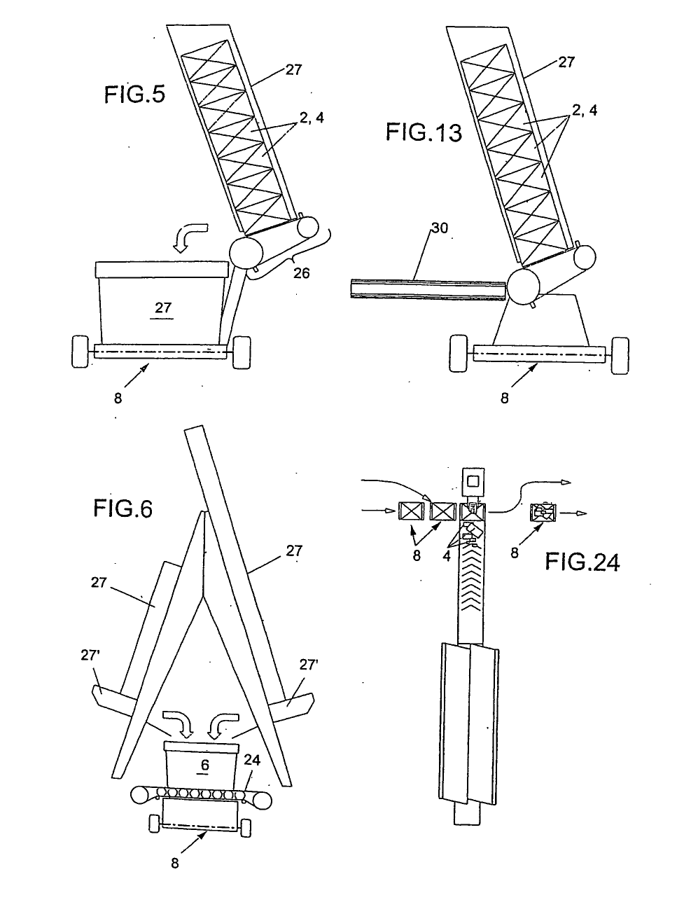

FIG. 4, FIG. 5 and FIG. 6 each show variants for different product transfers, in a side view.

FIG. 7 shows a top view of a section of the store.

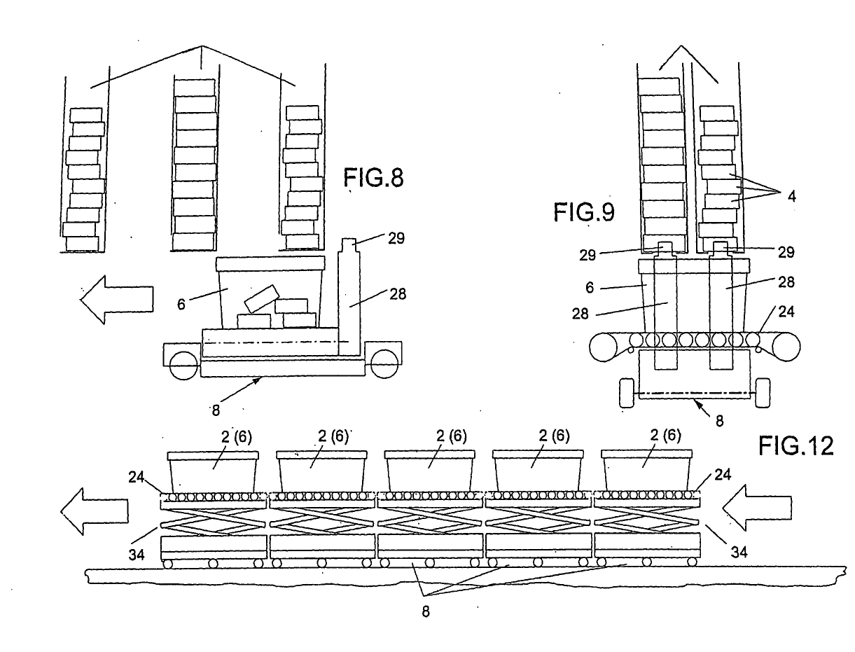

FIG. 8 shows a side view of a variant of a transfer of a product to a vehicle.

FIG. 9 shows a view in the direction of the arrow IX of FIG. 8.

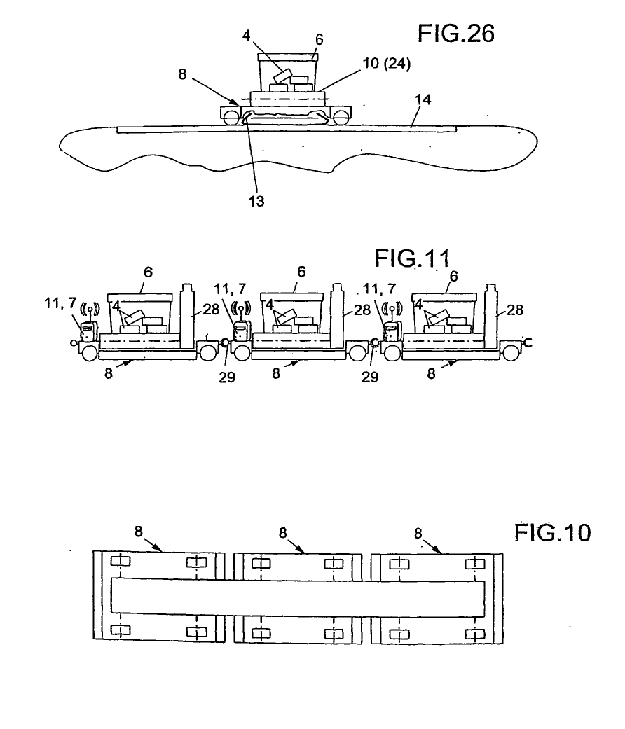

FIG. 10, FIG. 11 and FIG. 12 show a top view and side view of the combination of several vehicles into a functional unit.

FIG. 13 shows a side view of a conveying device.

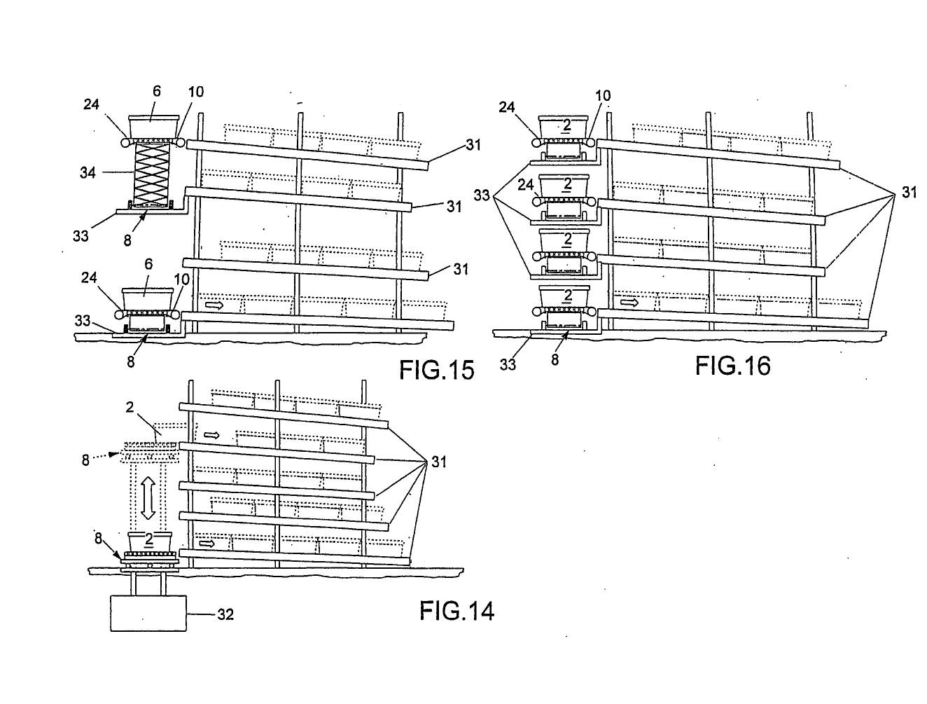

FIGS. 14 to 16 show a product store in a side view with different variants of the conveyance of products in a plurality of superimposed planes.

FIG. 17 shows the use of a vehicle as a conveying means from one storage area to another.

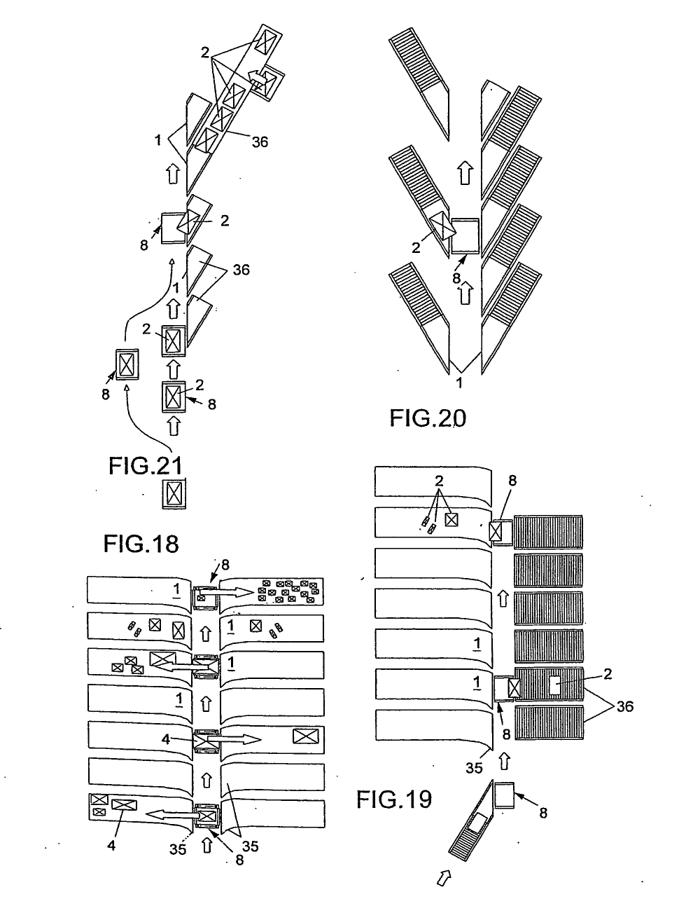

FIG. 18 to FIG. 24 show details of a store in a top view.

FIG. 25 shows a drive of a vehicle.

FIG. 26 shows a variant of a power and/or data supply of a vehicle.

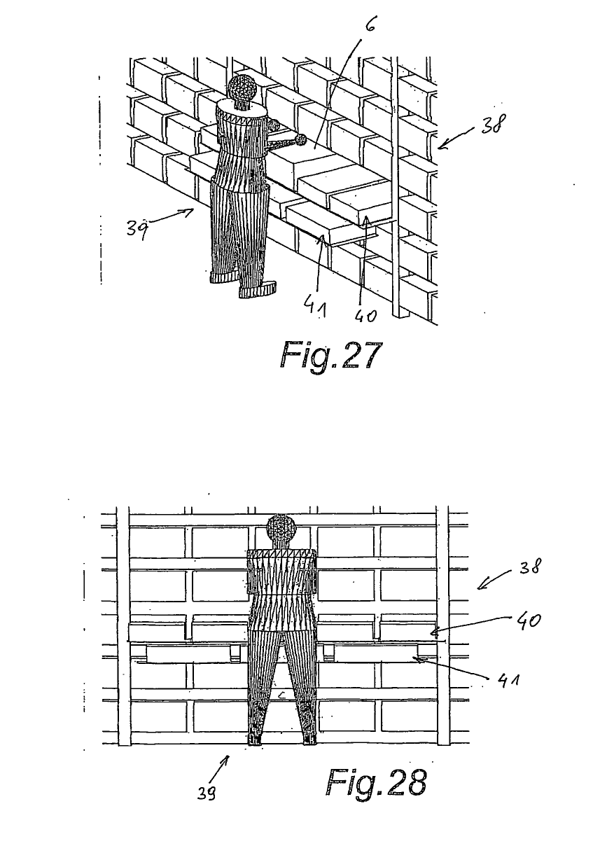

FIG. 27 and FIG. 28 show a simple commissioning workplace in a side view and front view.

In accordance with FIG. 1, products are housed and/or stored in a store in individual storage areas 1, which occurs in a shelf 3 or in a specific storage location, each specified for a product 2. Each product 2 can be formed by an individual packaged product 4 or goods 4 are arranged multiply in boxes 5 or transport containers 6, with each box 5 or transport container 6 forming a product 2 within the terms of the invention.

Vehicles 8 which are equipped with a computing unit 7 are displaceable between the storage areas 1 of racks or shelves 3, which occurs by means of a separate drive 9 (see FIG. 25). The same can be activated and deactivated by the computing unit 7. The vehicles 8 can be electrically driven, with batteries or storage batteries being used as power storage. Once the voltage level drops beneath a predetermined minimum level, the vehicle 8 can automatically drive to a battery exchange or battery loading station. As an alternative or in addition to this, other power sources such as fuel cells or solar cells can be used.

The ambient environment of each vehicle 8 is detected by means of sensors (not shown in close detail) which are of an optical or acoustic type in order to develop evasive strategies in due time in case of obstructions. They can be saved to the computing units of each vehicle 8 so as to allow them to retrieve them when necessary without having to use a central computer for this purpose. Optionally, the vehicles can also communicate among each other and find suitable measures for certain situations in this way. Strategies for fulfilling certain instructions are stored in databases or strategy libraries of the computing units 7 of the vehicles 8.

Vehicle 8 comprises a product rack 10 for at least one product 2. A data transmission device 11 is used for transmitting data entered preferably at a central switch point 12 to the computing unit 7 of the vehicle 8. Said data transmission device 11 can be arranged as a radio device and/or as an infrared interface and/or as an ultrasonic sound device. It is also possible to supply the vehicle 8 with the necessary data concerning a product 2 to be collected or delivered and/or a target in the store and/or a path to be covered and/or with power by means of sliding contacts 13 which act on lines 14 laid along the route (see FIG. 26).

As can be seen from FIG. 1 to FIG. 3, the store is not bound to any specific form. It can be equipped with devices for commissioning the products 2 or goods 4 as well as for automatic commissioning 15 or manual commissioning 16. Usually, the products 2 to be stored or commissioned are provided on the vehicles 8 at a location 17 and the empty vehicles 8 are collected at another location 18.

The vehicles 8 supplied with the desired products 2 or goods 4 are kept available in a dispatch readiness area 19 for dispatch once the previously loaded vehicles 8 have passed a testing station 20.

FIG. 4 illustrates the storage areas 1 in a rack 3 or shelf which are arranged in an inclined way and on which a product 2 moves over a gravity roller conveyor 23 as a result of gravity against a stop 22 situated at the front end 21 of the first storage area 1. Said stop 22 can be displaced to the side or upwards or downwards by means of a driver (not shown) of the vehicle 8 which is optionally activated by the computing unit 7, i.e. it is brought to a position in which the product 2 or box 5 moves beyond the end 21 of the gravity roller conveyor 23, in which case the product 1 is grasped by an active loading and unloading element 24 which is situated on the vehicle 8, forms the product rack 10 and is arranged in the embodiment as shown in FIG. 2 as a conveyor belt and is moved onto the vehicle 8. When the vehicle then leaves said storage area 1, the stop 22 reaches back to its original position again, so that a product 2 following the gravity roller conveyor 23 again only moves up to the end 21 of the gravity roller conveyor 23 against the stop 22. It is also possible to lift a product 2 by means of drivers 25 arranged on the loading and unloading element 24 over the stop 22 and thus to move the same completely onto the product rack 10.

The delivery of the product 2 occurs at the desired location also by activating conveyor belt 24, preferably via the computing unit 7 of the vehicle 8. Instead of the conveyor belt it is also possible to provide a chain conveyor or driven rollers (see FIG. 17). The conveying direction need not necessarily occur transversally to the direction of travel of the vehicle 8, as is shown in FIG. 4, but can occur in the longitudinal direction of the traveling direction if necessary, e.g. by a changed arrangement of the conveyor belt or a gravity roller conveyor formed by driven rollers, as is shown in FIG. 17.

According to FIG. 5, a container 6 is arranged as a product container on the product rack 10 of vehicle 8 and the vehicle 8 comprises a conveying device 26 for removing a product 2 or merchandise 4 from a stack of products 2 which are arranged in a drop chute 27. By activating said conveying device 26 by means of the computing unit 7, a certain number of products 2 can be removed from the drop chute 27 and be deposited in the container 6.

FIG. 6 shows a similar device with drop chutes 27. A release of a product 2 or a merchandise 4 occurs here by a device 27′ (ejector) at the drop chutes 27 themselves. Said device 27′ can preferably also be triggered via the computing unit 7 of the vehicle 8.

FIG. 7 illustrates the removal and delivery of a product 2 from and to a storage area 1 of the store.

FIG. 8 and FIG. 9 also show a removal of a merchandise 4 or a product 2 from products 2 or wares 4 stacked in drop chutes 27, with the lowermost merchandise being conveyed by a driver device 28 arranged on the vehicle 8 into a container 6 situated on the product rack 10 of the vehicle 8. The driver device 28 can be activated or deactivated by the computing unit 7 of the vehicle 8, with a driver pin 29 protruding from the driver device 28, which pin comes into contact with the lowermost product 2 in the activated state.

The FIG. 10, FIG. 11 and FIG. 12 show the link-up of several vehicles 8 by means of couplings 29, which can preferably be activated by the computing units 7 of the vehicles 8, into a functional unit. In accordance with FIG. 10 said functional unit is used to transport a large bulky product 2 which could not be conveyed with a single vehicle 8, and is used according to FIGS. 11 and 12 to simultaneously convey a plurality of products 2 or goods 4. It may also be necessary under certain circumstances to use this functional unit itself as a conveying device when the vehicles 8 are stationary (see FIG. 12, such that a product 2 is supplied to the last vehicle 8 of said functional unit and is conveyed by means of an activated roller conveyors 24 or conveyor belts 24 of the vehicles 8 to the first vehicle 8 of the functional unit and is delivered there to a storage area 1.

FIG. 13 illustrates a variant according to which a vehicle 8 is not used for transporting a product 2 or a merchandise 4, but merely for removing a product from a drop chute 27 and for conveying the same to a conveying device 30 such as a conveyor belt positioned adjacent to the vehicle 8.

FIG. 14 to FIG. 16 illustrates a store with products 2 which are stored in several planes 31 which are arranged above one another. In order to supply these planes 31 with a vehicle 8, there are several possibilities. Either the entire vehicle 8 itself is lifted with a lifting device 32 to the correct height, as shown in FIG. 124, or the vehicle 8 reaches via a ramp a track 33 which is arranged at the respective height of the storey (FIG. 15 and FIG. 16). A further possibility is shown by FIG. 15, according to which the vehicle 8 is equipped itself with a lifting device 34 for the product rack 10.

FIG. 18 and FIG. 19 illustrate the transfer of products to storage areas 1 during the travel of the vehicles 8, for which purpose the storage areas 1 are provided with product receptacles 35 directed in the direction opposite to the traveling direction of the vehicle 8. A product 2 reaches via a vehicle 8 to a dispatch ramp 36. A similar device with inclined dispatch ramps 36 is also shown in FIG. 20.

FIG. 21 illustrates a situation in which a vehicle 8 overtakes other vehicles 8 which are positioned close to a storage area 1. It concerns a sorting installation with determination of the sorting sequences with a possibility for prioritizing individual products 2.

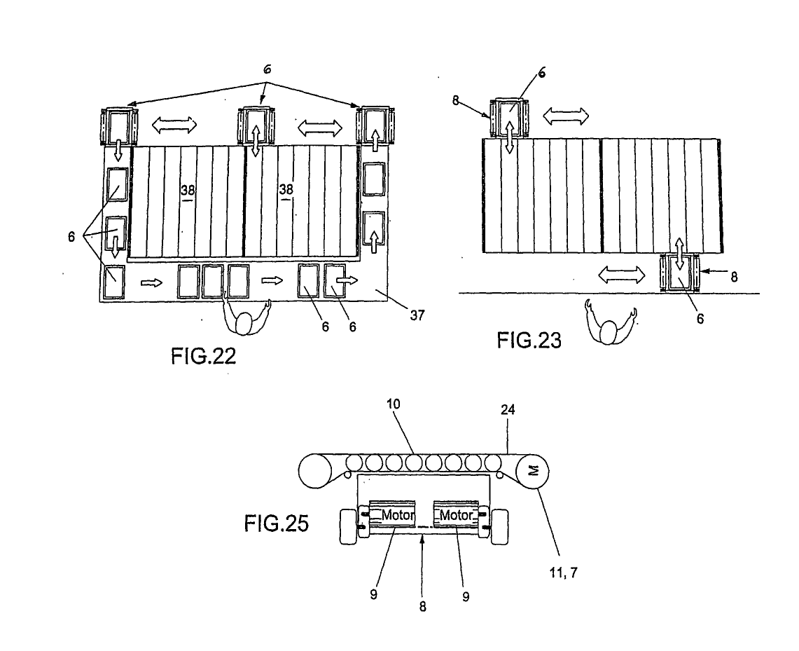

FIG. 22 and FIG. 23 illustrate commissioning stations, namely according to FIG. 22 with fixedly installed conveying technology 37 and according to FIG. 23 in combination with conveying technology and use of vehicles 8 and automatic refilling of shelves 38.

The shelves 38 can also only be arranged as storage places with single depth for containers 6 and the merchandise can be commissioned either from the shelves 38 onto the carriages 8 or containers 6 or vice-versa.

In connection with the relevant invention, especially simple commissioning workplaces 33 are obtained which can be integrated in a compact manner directly into the shelf 38 (see FIG. 27). The rows of shelves can be arranged in a slightly offset manner in the commissioning area for the purpose of easier reachability of the containers 6. The storage places for the container 6 can still be easily reached by the vehicles 8 because they are able to navigate freely in the shelf 38.

Commissioning is performed either from the upper plane 40 to the lower plane 41 or vice-versa.

The commissioning can be supported by pick-by-light or pick-by-voice systems. Furthermore, the workplace can be equipped with screen support or other user guidance systems.

FIG. 24 relates to a filling station of an automatic commissioning system in which containers 6 situated on the vehicle 8 can be equipped with different products.

1.-20. (canceled)

21. A method for transporting goods, comprising at least one vehicle which can be autonomously displaced in a store, comprising:
a vehicle provided with a computing unit receives, preferably by radio, at least one instruction relating to:
a) a product to be fetched or delivered, and/or
b) a target location, e.g., a storage area in the store, and/or
c) a path to be covered;
whereupon the computing unit of the vehicle establishes
the target location and the optimum or approximately optimum route for instruction a);
and the optimum or approximately optimum route for the instruction b);
and starts the displacement transaction for the instructions a) or b) or c);
with the vehicle being activated by the computing unit at the target location, in such a way as to automatically receive or deliver the product or to load and unload the same;
whereupon optionally, if another instruction is provided, another product is fetched or the loaded product is guided to another target location defined in an instruction relating to a), b) and/or c).

22.-30. (canceled)

31. An installation for transporting goods comprising the following:
a store for products, comprising a plurality of storage areas determined for the products;
at least one route along and/or between the storage areas;
at least one autonomously displaceable vehicle equipped with a computing unit;
with a product rack for at least one product;
with a running gear that can be activated by the computing unit, and
with a data transmission device for transmitting data sent at a switch point to the computing unit of the vehicle.

32.-40. (canceled)

41. The method according to claim 21, wherein the vehicle receives at least one instruction by radio.

42. The method according to claim 21, wherein the loading or unloading of the vehicle occurs passively, with at least one active loading or unloading element being activated upon arrival of the vehicle.

43. The method according to claim 42, wherein the loading or unloading element is situated in the store.

44. The method according to claim 42, wherein the loading or unloading element is activated by means of the vehicle itself.

45. The method according to claim 21, wherein the loading and unloading of the vehicle occurs actively, for which purpose a displaceable loading or unloading element is activated which is arranged on the vehicle.

46. The method according to claim 45, wherein the loading or unloading element is selected from the group conveyor belt, conveyor chain and conveyor rollers.

47. The method according to claim 45, wherein the loading or unloading element is activated by the vehicle itself.

48. The method according to claim 21, wherein the loading and unloading of the vehicle occurs automatically upon arrival of the vehicle at a loading or unloading point, i.e., by ejector devices provided on the vehicle.

49. The method according to claim 21, wherein the loading and unloading of the vehicle occurs automatically upon arrival of the vehicle at a loading or unloading point, i.e., by gravity.

50. The method according to claim 21, wherein at least two vehicles cover at least a part of the route together by forming a functional unit.

51. The method according to claim 50, wherein at least two vehicles jointly transport a product which with respect to its dimensions exceeds the dimensions of an individual vehicle.

52. The method according to claim 50, wherein the loading or unloading of the functional unit is performed for the individual vehicles in parallel, i.e., simultaneously, or serially, i.e., by forwarding at least one product from vehicle to vehicle.

53. The method according to claim 21, wherein at least two vehicles are combined into a functional unit and are used for conveying a product from one vehicle at one end to a vehicle at the other end of the functional unit.

54. The method according to claim 21, wherein a product is conveyed by means of a vehicle in a vertical direction, which occurs by lifting or lowering a product rack provided on the vehicle.

55. The method according to claim 21, wherein a vehicle is lifted or lowered from a plane to a plane situated vertically above or below the same.

56. The method according to claim 21, wherein the loading or unloading of a vehicle or a functional unit occurs when the vehicle is traveling or when the functional unit is traveling.

57. The installation according to claim 31, with a vehicle with an active loading or unloading element which supplies the product rack and can be activated by the computing unit and acts transversally to or along the traveling direction of the vehicle.

58. The installation according to claim 31, with a vehicle whose product rack itself is arranged as a conveying device which acts transversally to or along the traveling direction of the vehicle, which product rack can be activated by the computing unit.

59. The installation according to claim 31, wherein the product rack of the vehicle can be lifted or lowered by means of a lifting device which can be activated by the computing unit.

60. The installation according to claim 31, wherein the vehicle is provided with an ejector device for the automatic loading or unloading in or from gravity chutes.

61. The installation according to claim 60, wherein the ejector device can be activated by means of the computing unit from an active position to a passive position and vice-versa.

62. The installation according to claim 31, with at least two vehicles which are equipped with a coupling device and which can be coupled into a functional unit

63. The installation according to claim 62, wherein the coupling devices can be activated by means of the computing unit.

64. The installation according to claim 31, with a data transmission device for transmitting data entered at a switch point to the computing unit.

65. The installation according to claim 64, wherein the data transmission device is arranged as a radio device.

66. The installation according to claim 64, wherein the data transmission device is arranged as a infrared device.

67. The installation according to claim 64, wherein the data transmission is arranged as a plug-in connection.

68. The installation according to claim 64, wherein the data transmission device is a realized by sliding contacts.

69. The installation according to claim 64, wherein the data transmission device is arranged as an ultrasonic device.

70. The installation according to claim 31, with at least one storage area with an active loading or unloading element.

71. The installation according to claim 70, wherein the loading and unloading element can be activated by the computing unit of the vehicle.

72. The installation according to claim 31, with a lifting and lowering device which is adjacent to a storage area.

73. The installation according to claim 72, wherein the lifting and lowering device can be activated by the computing unit of the vehicle.

74. The installation according to claim 31, with a storage area which is equipped with a gravity-induced conveying device with the storage area being provided on the track with a stop device for a product which can be activated or deactivated by the vehicle, either mechanically by the arrival at or movement of the vehicle past the storage area or by a computing unit.

75. The installation according to claim 74, wherein the conveying device is an inclined gravity roller conveyor.
